(19) United States
(12) Patent Application Publication
(10) Pub. No.: US 2026/0270811 A1
(43) Pub. Date: Sep. 10, 2026

(54) TECHNOLOGIES FOR MANAGING SYNCHRONIZATION SIGNAL MEASUREMENT TIMING CONFIGURATIONS

(71) Applicant: Apple Inc., Cupertino, CA (US)

(72) Inventors: Fangli Xu, Beijing (CN); Chunhai Yao, Beijing (CN); Yuqin Chen, Beijing (CN); Haijing Hu, Los Gatos, CA (US); Jie Cui, San Jose, CA (US); Dawei Zhang, Saratoga, CA (US); Chunxuan Ye, San Diego, CA (US)

(73) Assignee: Apple Inc., Cupertino, CA (US)

(21) Appl. No.: 18/875,097

(22) PCT Filed: Dec. 13, 2024
(86) PCT No.: PCT/CN2023/143698

§ 371 Date: Dec. 13, 2024

(51) Int. Cl. H04W 36/00; H04W 36/08; H04W 84/06

(52) U.S. Cl. CPC H04W 36/0072; H04W 36/0085; H04W 36/083; H04W 84/06

(57) ABSTRACT

The present application relates to devices and components including apparatus, systems, and methods for managing synchronization signal measurement timing configurations.

### FIELD

This application relates to the field of wireless networks and, in particular, to technologies for managing synchronization signal measurement timing configurations.

### BACKGROUND

As wireless networks have developed, the networks have grown to service more areas and more remote areas. An approach that has been proposed for the wireless networks to service more areas and more remote areas is the utilization of non-terrestrial networks (NTNs). In particular, satellites may be utilized within the NTNs to provide radio access network (RAN) service. This may address mobile broadband needs and public safety needs in unserved or underserved areas. NTNs may improve connectivity in a variety of scenarios including, for example, maritime, airplane, and railway scenarios. The use of the satellites within the NTNs presents many challenges.

### BRIEF DESCRIPTION OF THE DRAWINGS

FIG. 1 illustrates a network arrangement in accordance with some embodiments.

FIG. 2 illustrates a hard-switch operation in accordance with some embodiments.

FIG. 3 illustrates a soft-switch operation in accordance with some embodiments.

FIG. 4 illustrates a switch procedure in accordance with some embodiments.

FIG. 5 illustrates another switch procedure in accordance with some embodiments.

FIG. 6 illustrates another switch procedure and timing diagram in accordance with some embodiments.

FIG. 7 illustrates another switch procedure and timing diagram in accordance with some embodiments.

FIG. 8 illustrates another switch procedure and timing diagram in accordance with some embodiments.

FIG. 9 illustrates a transmission and timing diagram in accordance with some embodiments.

FIG. 10 illustrates another switch procedure and timing diagram in accordance with some embodiments.

FIG. 11 illustrates an operational flow/algorithmic structure in accordance with some embodiments.

FIG. 12 illustrates another operational flow/algorithmic structure in accordance with some embodiments.

FIG. 13 illustrates another operational flow/algorithmic structure in accordance with some embodiments.

FIG. 14 illustrates a user equipment in accordance with some embodiments.

FIG. 15 illustrates a network device in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, and techniques in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B); the phrase “(A) B” means (B) or (A and B), that is, A is optional; and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components that are configured to provide the described functionality. The hardware components may include an electronic circuit, a logic circuit, a processor (shared, dedicated, or group) or memory (shared, dedicated, or group), an application-specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), or a digital signal processor (DSP). In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer to an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, and network interface cards.

The term “user equipment” or “UE” as used herein refers to a device with radio communication capabilities that may allow a user to access network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, or reconfigurable mobile device. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, or workload units. A “hardware resource” may refer to compute, storage, or network resources provided by physical hardware elements. A “virtualized resource” may refer to compute, storage, or network resources provided by virtualization infrastructure to an application, device, or system. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel.” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refer to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, or a virtualized network function.

The term “information element” refers to a structural element containing one or more fields. The term “field” refers to individual contents of an information element, or a data element that contains content. An information element may include one or more additional information elements.

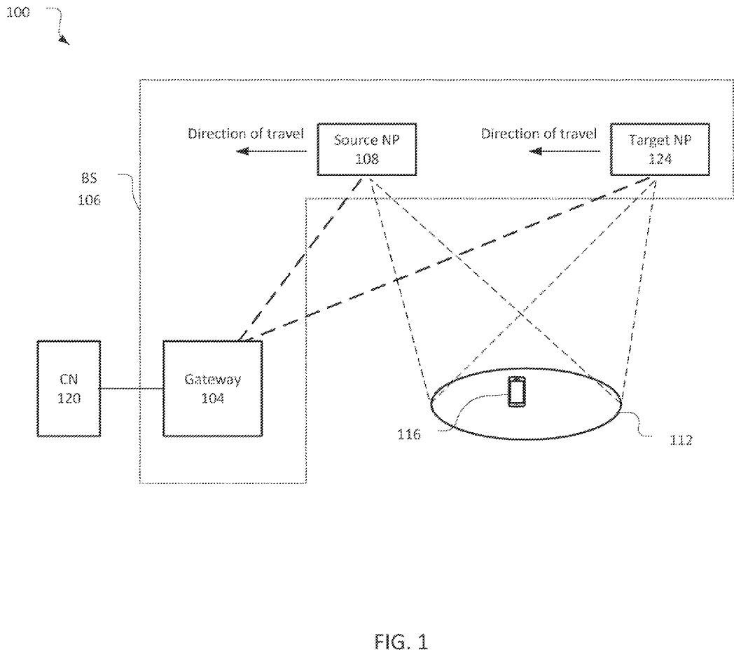

FIG. 1 illustrates an example network arrangement 100 in accordance with some embodiments. The network arrangement 100 may employ one or more non-terrestrial components and may, therefore, be referred to as a non-terrestrial network (NTN).

The network arrangement 100 may include a gateway 104 coupled with a source NTN payload (NP) 108 to provide a serving cell 112 for a user equipment (UE) 116. The gateway 104 and the source NP 108 may collectively be referred to as a base station 106. The base station 106 may be part of a radio access network (RAN) that provides services to UEs such as the UE 116. The gateway 104, which may be a terrestrial component of the base station 106, may be coupled with the source NP 108 by a feeder link. The source NP 108, which may be a non-terrestrial component of the base station 106, may be coupled with the UE 116 by a service link that supports a Uu interface (e.g., a New Radio (NR) Uu interface). The serving cell 112 may be associated with a larger geographic area than a serving cell provided by a terrestrial network.

In some embodiments, the source NP 108 may transparently forward communications between the gateway 104 and the UE 116. In other embodiments, the source NP 108 may include additional base station functionality. The gateway 104 may serve one or more NPs and the source NP 108 may be served by one or more gateways.

The network arrangement 100 may also include a core network (CN) 120 coupled with the gateway 104 via a fiber optic or wireless backhaul. The CN 120 may provide functions for the UEs that form a connection with the base station, such as subscriber profile information, subscriber location, authentication of services, or switching functions for voice and data sessions.

As used herein, operations described with respect to a “network” may be performed by one or more components of a RAN (for example, base station 106) or the CN 120.

In some embodiments, the source NP 108 may provide a quasi-earth-fixed service link by using beam(s) to provide the serving cell 112 for a geographic area for limited time. As the source NP 108 moves away from the geographic area associated with the serving cell 112, provision of the serving cell 112 may be switched to a target NP 124. The target NP 124 may establish a feeder link with the gateway 104 (and become part of the base station 106) and may take over the quasi-earth-fixed service link that provides the serving cell 112. In some embodiments, the physical cell identity (PCI) associated with the serving cell 112 may be the same before and after the switch. NP switching without PCI change may not require layer 3 (L3) mobility.

The NPs 108/124 may be spacebome vehicles such as, for example, low-Earth orbit (LEO) satellites, medium-Earth orbit (MEO) satellites, geosynchronous Earth orbit (GEO) satellites, or high-Earth orbit (HEO) satellites. The NPs 108/124 may additionally/alternatively be airborne vehicles such as, for example, high-altitude platform stations (HAPS) or other atmospheric satellites.

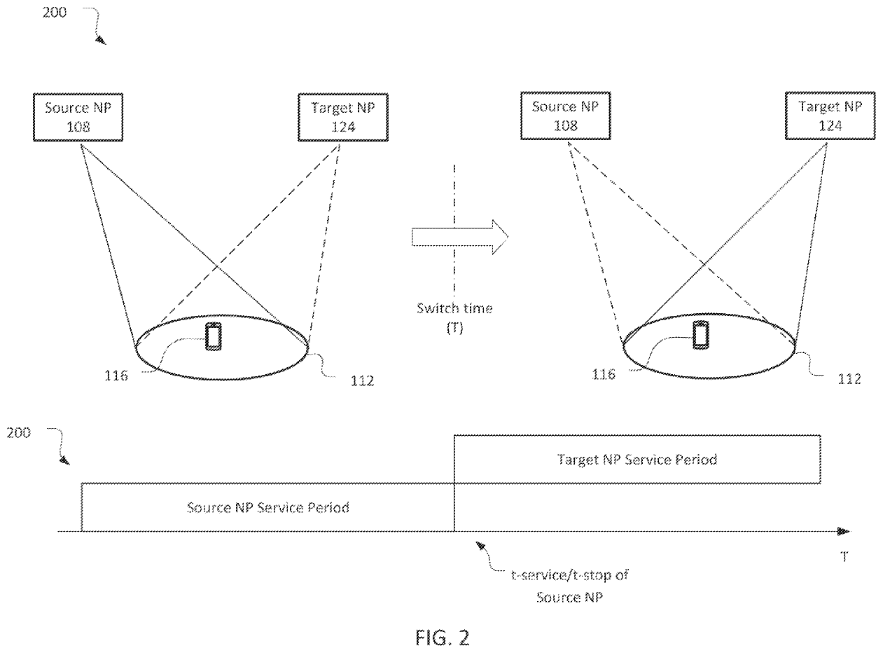

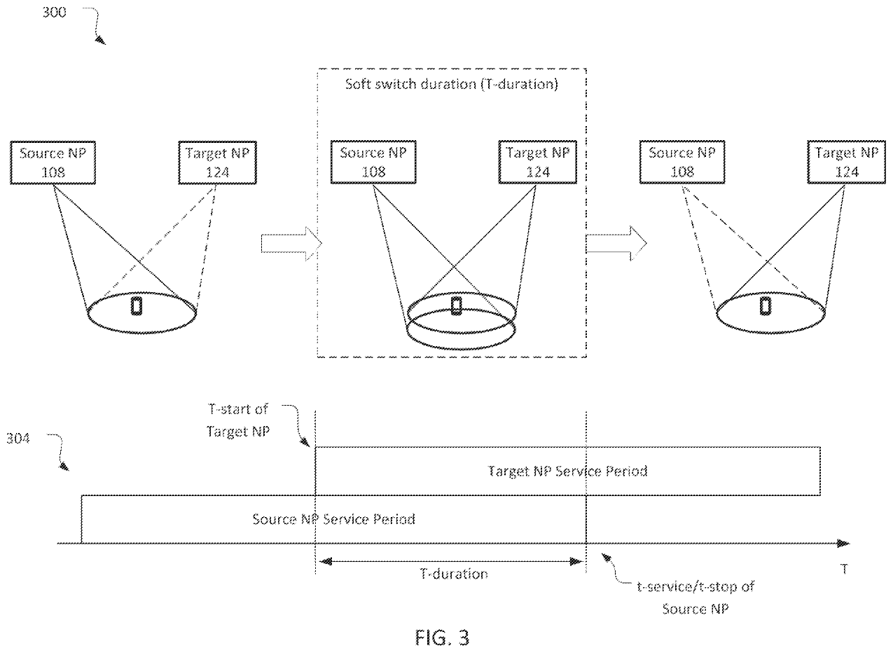

Switching between the source NP 108 and the target NP 124 may occur through a hard-switch operation or a soft-switch operation as described in FIGS. 2 and 3 in accordance with some embodiments.

FIG. 2 illustrates a hard-switch operation 200 in accordance with some embodiments. As shown in the timing diagram 204, in the hard-switch operation 200, the source NP 108 may provide the serving cell for a first service period (source NP service period) and the target NP 124 may provide the serving cell 112 for a second service period (target NP service period). Provision of the serving cell 112 may switch from the source NP 108 to the target NP 124 at a switch time (T). In the hard-switch operation 200, the source NP service period does not overlap with the target NP service period. Thus, t-Stop (for example, point at which the source NP service period stops) may be at the switch time (T). The point at which a current cell stops may also be referred to as t-service.

FIG. 3 illustrates a soft-switch operation 300 in accordance with some embodiments. As shown in the timing diagram 304, in the soft-switch operation 300, the source NP 108 may provide the serving cell for a first service period (source NP service period) and the target NP 124 may provide the serving cell 112 for a second service period (target NP service period). In the soft-switch operation 300, the serving cell 112 may be provided by both the source NP 108 and the target NP 124 for a soft-switch duration (T-duration). The UE 116 may select a time within the soft-switch duration to start synchronizing with the target NP 124 to switch a connection from the source NP 108 to the target NP 124.

The UE 116 may synchronize with the serving cell 112 by using synchronization signal/physical broadcast channel block (SSBs) transmitted by the source NP 108 and the target NP 124. In addition to facilitating synchronization, these SSBs may be allow for serving cell measurements that may serve as a basis for managing beams and other transmission/reception parameters in the serving cell 112.

An NP may transmit a plurality of SSB bursts in an SSB burst set. The transmission duration of the SSB burst may be one half frame, for example, 5 milliseconds (ms). The SSB bursts may include a transmission periodicity of 5, 10, 20, 40, 80, or 160 ms. For initial acquisition, the UE 116 may assume a periodicity of 20 ms. A maximum number of SSBs in an SSB burst may be band dependent. For example, the maximum number of SSBs may be four for operating frequencies up to 3 gigahertz (GHz), eight for operating frequencies from 3-6 GHz, and 64 for operating frequencies up to 52.6 GHz. An indication of the number of SSBs actually transmitted may be provided in remaining minimum system information (RMSI). The subcarrier spacing (SCS) numerology may also be band dependent. For example, the SCS in Frequency Range 1 (FR1) may be 15 or 30 kHz, while the SCS in Frequency Range 2 (FR2) may be 120 or 240 KHz.

The UE 116 may be configured with an SSB measurement timing configuration (SMTC) via RRC signaling. The SMTC may configure timing occasions (or measurement windows) at which the UE 116 may measure the SSBs. The SMTC may include a periodicity and offset (periodicityAndOffset) parameter that configures a periodicity and offset of the timing occasions. The periodicity may be 5, 10, 20, 40, 80, or 160 subframes, which may correspond to SSB broadcast ranges of 5, 10, 20, 40, 80, or 160 ms, and the offset may be an integer selected from a range that depends on the periodicity. For example, if the periodicity is: five subframes, the offset may be 0-4; 10 subframes, the offset may be 0-9; 20 subframes, the offset may be 0-19; 40 subframes, the offset may be 0-39; 80 subframes, the offset may be 0-79; 160 subframes, the offset may be 0-159.

With a given periodicity and offset, the first subframe of each SMTC occasion may occur at a system frame number (SFN) and subframe (subframe) of the serving cell 112 as defined as follows in, for example, clause 5.5.2.10 of 3GPP TS 38.331 v17.6.0 (2023-09-28):

```
SFN mod T = (FLOOR (offset/10));
if the periodicity is larger than [5 subframes] sf5:
  subframe = offset mod 10;
else:
  subframe = offset or (offset + 5);
with T = CEIL(Periodicity/10),
```

where T is a measurement gap repetition period (MGRP)/10.

The SMTC may also set a duration of the measurement window to 1, 2, 3, 4, or 5 subframes. In other embodiments, other values may be used for the parameters of the SMTC.

For neighbor cell measurements, current networks rely on UEs adjusting an SMTC to account for different propagation delays of service links in NTNs. For a CONNECTED mode UE, the network (NW) may control adjustment of SMTCs based on UE assistance information report. The UE assistance information may include information on service link propagation delay difference(s) (PDD(s)) between a serving cell and neighbor cell(s). For an IDLE/INACTIVE mode UE, the UE can adjust SMTCs based on its location and assistance information in a system information block (SIB) 19. An SMTC may be based on assumption that a propagation delay difference between the serving cell and neighbor cells equals 0 ms, and a UE can adjust the actual offset based on an actual propagation delay difference.

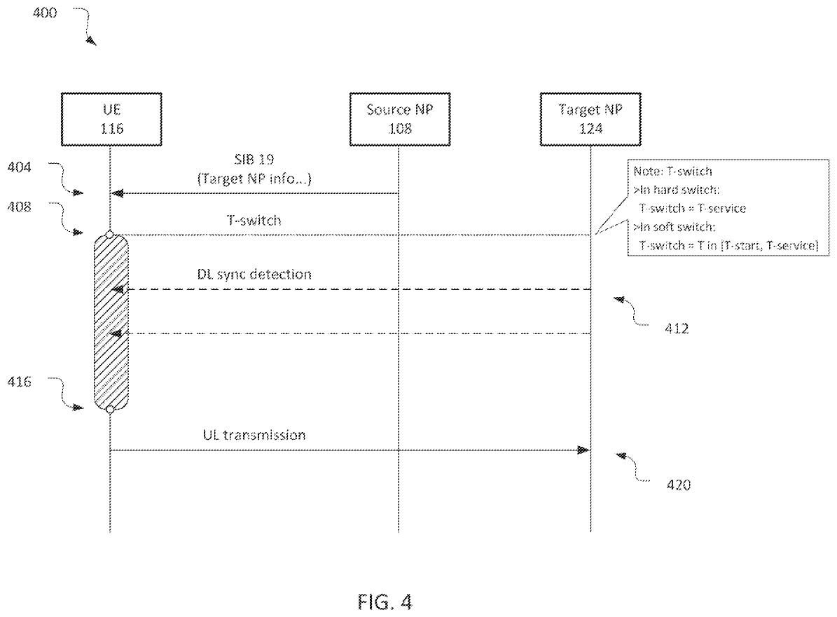

FIG. 4 is a switch procedure 400 in accordance with some embodiments.

The switch procedure 400 may include, at 404, the UE 116 receiving a system information block (SIB) message. The SIB message may be transmitted by the source NP 108. In some embodiments, the SIB message may be a SIB 19 message that includes target NP information. The target NP information may include, for example, an NTN configuration of the target NP 124. This may include ephemeris information regarding a position or course of the target NP 124. In some embodiments, the SIB message may include SSB information such as an SSB index, an SSB time offset, etc.

The switch procedure 400 may further include, at 408, a switch time (T-switch). In a hard switch, the switch time may be the time in which the source NP service period ends and the target NP service period begins (for example, T-service). In a soft switch, the switch time may be a time selected within the soft switch duration, which may start of the target NP service period (for example, T-start) and end at an end of the source NP service period (for example, T-service/T-stop).

At 408, an RRC layer of the UE 116 may consider an uplink synchronization timer (for example, a T430 timer) expired and indicate, to a media access control (MAC) layer of the UE 116, that an NP switch procedure has started. The MAC layer may then flush a hybrid automatic repeat request (HARQ) buffer and suspend uplink transmission.

The switch procedure 400 may further include, at 412, detecting a downlink (DL) synchronization (sync) of the target NP 124. In some embodiments, the DL sync detection may be based on a provided SSB time offset.

In some embodiments, the DL sync detection may include the UE 116 performing an SMTC adjustment based on propagation delay difference (PDD) and SSB time offset, if provided. The UE 116 may then detect an SSB of the target NP 124 in a window of the adjusted SMTC.

At 416, once the UB 116 acquires the DL sync of the target NP 124, the RRC layer may start the T430 timer and indicate to the MAC layer that uplink synchronization for the NP switch is restored. The MAC layer may set a timing advance number (NTA) to zero, clear a UE-specific Koffset (used to allow the UE 116 sufficient processing time between a downlink reception and an uplink transmission), resume an uplink transmission at 420, and trigger a timing advance report (TAR) and TAR-scheduling request (SR) if the UE 116 supports TAR as legacy.

If a timing advance timer is running, the uplink transmission at 420 may be transmitted via a physical uplink control channel (PUCCH) SR or a physical uplink shared channel (PUSCH) scheduled by a configured grant or dynamic grant. If the timing advance timer is not running and no PUCCH SR available, the UE 116 may trigger a RACH for the uplink transmission.

In embodiments in which NP switching occurs with unchanged PCI, the SSBs transmitted by the source NP 108 and the target NP 124 may have same or different configurations. This may, in part, depend on whether a hard-switch operation or soft-switch operation is enabled. For hard-switch operations, the source NP 108 and target NP 124 may use the same SSB configurations or different SSB configurations. For soft-switch operation, the source NP 108 and the target NP 124 may use different SSB configurations.

At least for soft-switch operation, an “SSB time offset” may be provided to the UE 116 that defines an offset between SSBs transmitted by the source NP 108 and SSBs transmitted by the target NP 124. The SSB time offset may be signaled, to the UE 116, in an information element (IE). The IE may have a format similar to the “offset” in SSB-measurement timing configuration (MTC) 4. In some embodiments, the SSB time offset may be transmitted to the UE 116 in the SIB 19. The UE 116 may autonomously track the SSBs of the target NP 124 using the SSB time offset.

Embodiments of the present disclosure describe aspects of SMTC configuration and UE operation to facilitate NP switching. Some embodiments describe whether and how to provide the SMTC configuration of target NP 124 and how the UE 116 handles SMTC adjustment. In particular, some embodiments describe provision of SMTC configuration in a manner that is beneficial for the UE 116 to acquire SSB of the target NP 124 for DL sync and for measurement. Additional embodiments specify methods to support acquisition, by the UE 116, of the actual SMTC configuration of the target NP 124 during the NP switching procedure.

In a first aspect, the UE 116 may follow network configuration to apply an SMTC configuration. The network may provide an updated SMTC configuration based on timing/propagation delay (PD) of the target NP 124. It may be up to an implementation of the UB 116 as to how it may perform serving measurement based on the original SMTC provided by the network before receiving the updated SMTC from the network.

In a second aspect, the UE 116 may autonomously perform an SMTC adjustment. The adjustment may be performed for measurement of the serving cell 112 or a neighbor cell. For the serving cell measurement, the UE 116 may adjust the SMTC based on an assumption that a UE-base station delay is zero or it may adjust the SMTC based on a PDD between the source NP 108 and the target NP 124. This PDD may be referred to as a source-target PDD. For the neighbor cell measurement, the UE 116 may either not perform an adjustment, or adjust the SMTC based on the source-target PDD or based on an assumption that a UE-base station delay is zero.

In some embodiments, both aspects may be supported by components of the network arrangement 100. The network may then control which aspect is to be used. For example, in some embodiments, the first aspect may be supported as a default and the network may use signaling to indicate whether the second aspect is enabled for NP switching. In some embodiments, the UE 116 may provide an indication of whether it supports the first or second aspects. This indication may be provided in UE capability signaling. If the UE 116 supports both aspects, the network may provide an indication of which aspect is to be used for NP switching.

Some embodiments also describe enhancements to assistance information provided by the UE 116. For example, in some embodiments, the UE 116 may report legacy PDD (for example, between a serving cell and a neighbor cell) to the network after NP switching. Thus, a new reporting trigger may be used to trigger a legacy PDD report. For another example, a new PDD (e.g., source-target PDD) may be defined, reported, or used as described herein.

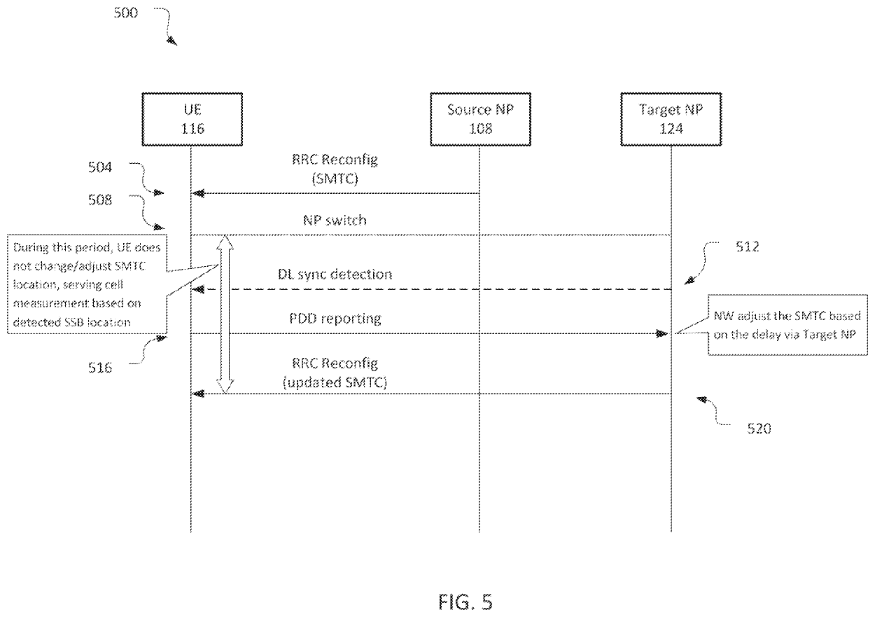

FIG. 5 is a switch procedure 500 in accordance with some embodiments. The switch procedure 500 may correspond to the first aspect introduced above. The switch procedure 500 may include a soft-switch operation or a hard-switch operation as described elsewhere herein. Except as otherwise described herein, the switch procedure 500 may be similar to the switch procedure 400.

The switch procedure 500 may include, at 504, the source NP 108 transmitting an RRC message to the UE 116. The RRC message, which may be an RRC reconfiguration message in some embodiments, may include an SMTC that is associated with the target NP.

The switch procedure 500 may further include, at 508, an NP switch. This may occur at a switch time (T).

The switch procedure 500 may further include, at 512, the UE 116 detecting a DL sync of the target NP 124. In some embodiments, the UE 116 may not be able to detect the SSB from the target NP 124 and perform the serving cell measurement appropriately based on the SMTC provided at 504. Thus, in some instances, the UE 116 may autonomously adjust a window based on a source-target PDD in order to track the SSB for DL SYNC. This may be done without adjusting the SMTC window used for serving cell measurements. The UB 116 may determine the source-target PDD by measuring a propagation delay associated with the target NP 124 and comparing that propagation delay with a previously measured propagation delay associated with the source NP 108. The window may additionally/alternatively be adjusted to track the SSB based on an SSB time offset provided to the UE 116.

The switch procedure 500 may further include, at 516, the UE 116 transmitting a PDD report to the base station 106 via the target NP 124. The PDD report may include an indication of the source-target PDD determined by the UE 116. The base station 106 may then adjust the SMTC based on the PDD report. For example, the SMTC may be adjusted based on the delay the UE 116 experiences with respect to the target NP 124.

The switch procedure 500 may further include, at 520, the base station transmitting an RRC message, via the target NP 124, to the UE 116. The RRC message, which may be an RRC reconfiguration message in some embodiments, may include the updated SMTC. The UE 116 may apply the updated SMTC and, for example, measure the serving cell 112 based on an SSB transmitted by the target NP 124.

During the period after the NP switch until receiving the updated SMTC at 520, the UE 116 may not adjust the SMTC window location, which is used for serving cell measurements, associated with the SMTC provided at 504. In some embodiments, the UE 116 may use the window adjusted for tracking the SSB position for serving cell measurement, regardless of the SMTC window location.

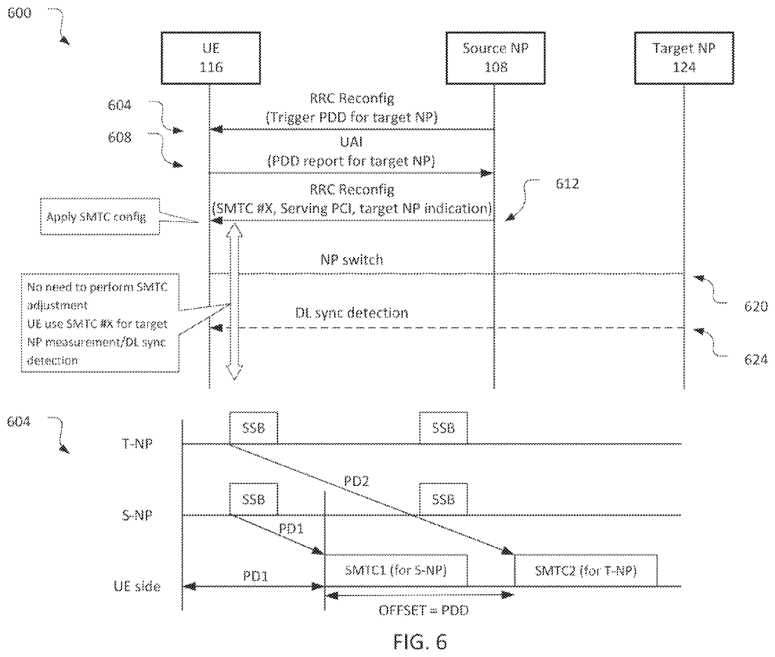

FIG. 6 is a switch procedure 600 and timing diagram 604 in accordance with some embodiments. The switch procedure 600 may also correspond to the first aspect introduced above. The switch procedure 600 may include a soft-switch operation or a hard-switch operation as described elsewhere herein. Except as otherwise described herein, the switch procedure 600 may be similar to switch procedure 400 or 500.

The switch procedure 600 may include, at 604, the source NP 108 transmitting an RRC message to the UE 116. The RRC message, which may be an RRC reconfiguration message in some embodiments, may include a trigger PDD for target NP. In some embodiments, the trigger PDD may include information associated with the target NP 124. For example, the trigger PDD may include ephemeris information associated with the target NP 124.

The UE 116 may determine the source-target PDD based on the trigger PDD and, at 608, transmit UE assistance information (UAI) to the source NP 108. The UAI may include a PDD report associated with the target NP 124. In particular, the PDD report may include an indication of the source-target PDD. The PDD report may be a one-shot report. For example, the UE 116 may generate and transmit one report per trigger PDD.

The network may use the source-target PDD provided at 608 to generate an SMTC associated with the target NP 124 (for example, SMTC #X). The SMTC may be based on source timing. Consider, for example, the timing diagram 604 illustrating timing of SSB transmissions from the target NP 124 (T-NP), SSB transmissions from the source NP 108 (S-NP), and UE-side configurations. When the UE 116 is under coverage by the source NP 108, the network may use PDI to provide the SMTC window for S-NP (for example, SMTC1) and an offset may be considered as zero. To provide the SMTC window for T-NP (for example, SMTC2 in 604 or SMTC #X in 600), the network may consider PDD as the offset within the periodicity. Thus, the window location for SMTC2/X may be set based on PDI and PDD.

The switch procedure 600 may further include, at 612, the source NP 108 transmitting an RRC message to the UE 116. The RRC message, which may be an RRC reconfiguration message, may include SMTC #X, an indication of the serving PCI associated with SMTC #X (for example, serving cell 112), and an indication of the target NP 124 to inform the UE 116 that the SMTC #X is to be used after the switch to measure SSBs transmitted by the target NP 124.

Upon receiving the RRC message at 612, the UE 116 may apply the SMTC #X.

The switch procedure 600 may further include, at 620, an NP switch that occurs at a switch time (T).

The switch procedure 600 may further include, at 624, the UE 116 using the SMTC #X for measuring the serving cell via the target NP 124 and detecting a DL sync. During and after the NP switch, the UE 116 may not need to adjust the SMTC.

For the second aspect in which the UE 116 performs an autonomous SMTC adjustment, there may be two options for the SMTC for the serving cell 112. In a first option, the network may provide an SMTC to cover SSBs for both the source NP 108 and the target NP 124. This may apply to a situation in which the source NP 108 and the target NP 124 use different SSBs (for example, in the soft-switch operation) or to a situation in which a same SSB is used by the source NP 108 and the target NP 124. In a second option, which may be used in a situation in which the source NP 108 and the target NP 124 use different SSBs, the network may provide a first SMTC for the source NP 108 and a second SMTC for the target NP 124.

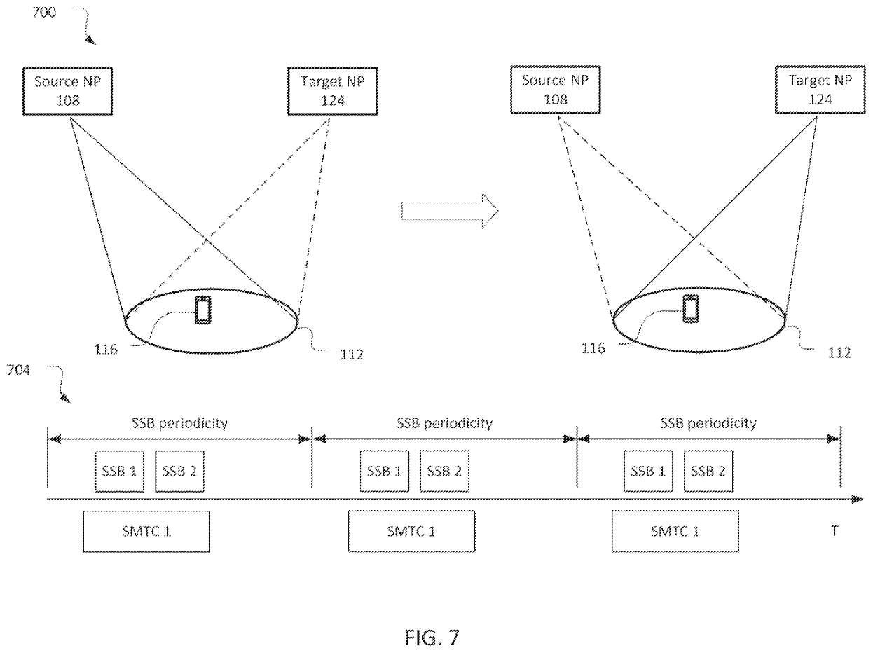

FIG. 7 is a switch operation 700 and accompanying timing diagram 704 showing SSB transmissions and an SMTC measurement window in accordance with option 1 of the second aspect. The timing diagram 704 illustrates SSB 1, which may correspond to an SSB burst transmitted by the source NP 108, and SSB 2, which may correspond to an SSB burst transmitted by the target NP 124. The UE 116 may be configured with one SMTC that defines a measurement window (SMTC 1) that covers both SSB 1 and SSB 2 in each period. In this embodiment, the network may only need to provide one SMTC. Thus, it does not need to provide an additional SMTC for the target NP 124.

The timing diagram 804 shows different SSBs used by the different NPS. However, if the same SSB is used by both the source NP 108 and the target NP 124, one SMTC may define the measurement window to cover the SSB in a similar manner.

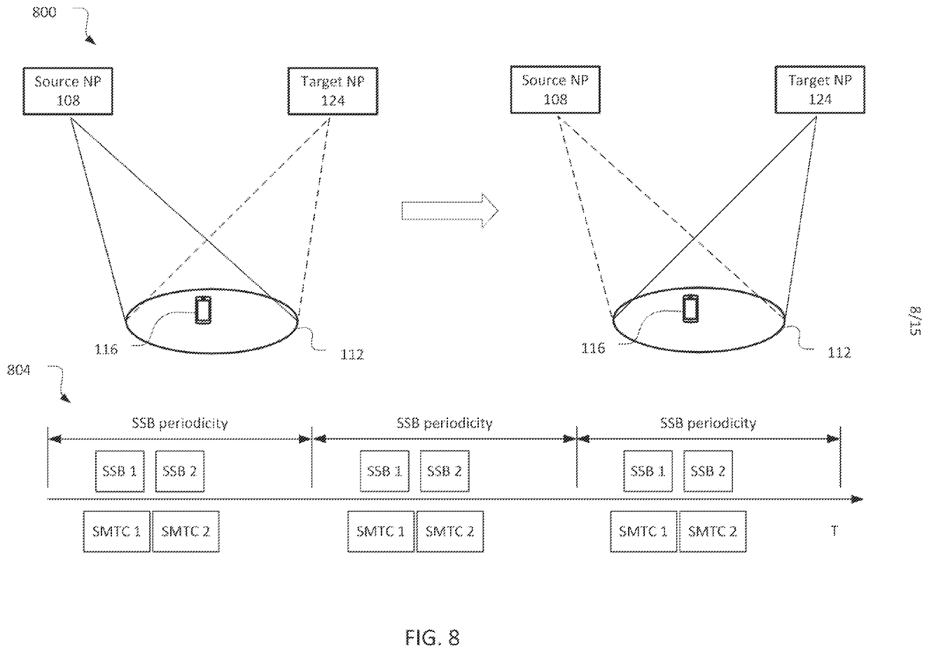

FIG. 8 illustrates a switch operation 800 and accompanying timing diagram 804 showing SSB transmissions and SMTC measurement windows in accordance with option 2 of the second aspect. The timing diagram 804 illustrates SSB 1, which may correspond to an SSB burst transmitted by the source NP 108, and SSB 2, which may correspond to an SSB burst transmitted by the target NP 124. In this embodiment, the UE 116 may be configured with two SMTCs each defining a measurement window in a measurement period. For example, a first SMTC may define a first measurement window (SMTC 1) that covers SSB 1 and a second SMTC may define a second measurement window (SMTC 2) that covers SSB 2. In this embodiment, the network may provide two SMTCs, one for the source NP 108 and one for the target NP 124.

In some embodiments, the network may provide the SMTC and associated SSB for the target NP 124 using system information transmitted by the source NP 108. For example, in some embodiments the information may be transmitted in a SIB 19. In some embodiments, the configuration may be provided in an SSB-MTC IE that is used to configure the timing occasions at which the UE 116 measures the SSB 2. The SSB-MTC IE configuration may be in the configuration of the target NP 124 of the same serving cell (for example, serving cell 112). In some embodiments, the SSB-MTC IE may define a measurement window with a periodicity of 5, 10, 20, 40, 80, or 160 ms. The SSB-MTC IE may further include an SSB positions in burst (SSB-PositionsInBurst) parameter to indicate a time-domain position of transmitted SSBs (for example, where the SSBs are transmitted within a given burst). The SSB-PositionsInBurst parameter may be a short bitmap (for example, four bits), a medium bitmap (for example, eight bits), or a long bitmap (for example, 64 bits). The first/leftmost bit of a bitmap may correspond to SSB index 0, the second bit may correspond to SSB index 1, etc. A value of 0 in the bitmap indicates an SSB is not transmitted and a value of 1 in the bitmap indicates an SSB is transmitted. The SSB-MTC IE may further include an SSB block power parameter that indicates an average energy per resource element (EPRE) of resource elements that carry secondary synchronization signals in dBm that the network used for SSB transmission. In some embodiments, the SSB block power parameter may have a range of about-60-50 dBm.

In some embodiments of the second aspect, the UE 116 may perform an SMTC adjustment for serving cell measurements. This may be done in accordance with a first or second option. In the first option, the UE 116 may perform an SMTC adjustment on its own initiative based on target NP assistance information from the SIB 19 and a location of the UE 116. In this option, it may be assumed that the network provides the SMTC configuration based on the UE-NP propagation delay of zero. In the second option, the UE 116 may perform an SMTC adjustment on its own initiative based on a source-target PDD. In this option, it may be assumed that the network provides the SMTC configuration based on an estimated source-target PDD of zero.

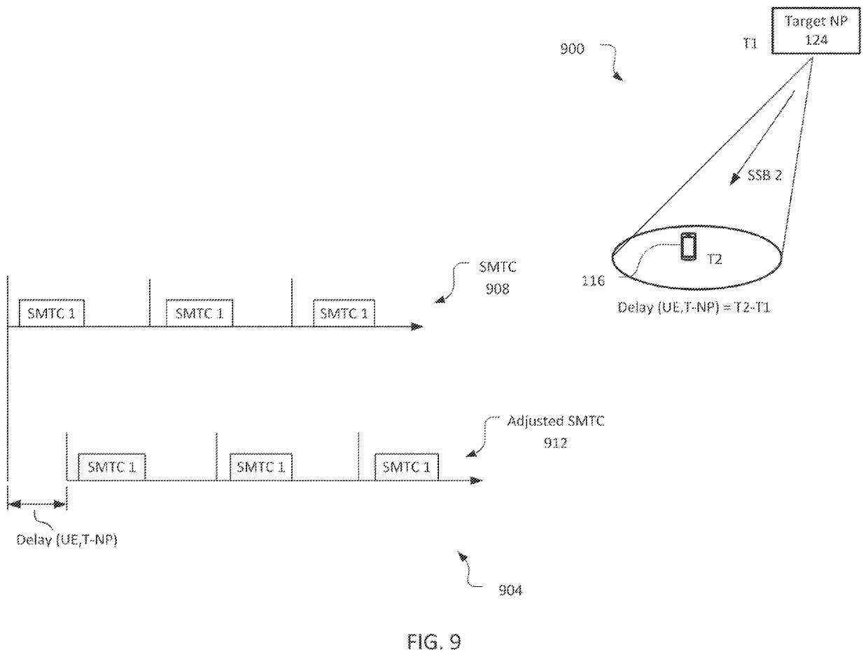

FIG. 9 illustrates SSB transmission 900 and an accompanying timing diagram 904 illustrating the first option of the second aspect for performing the SMTC adjustment at the UE 116 in accordance with some embodiments. A propagation delay between the target NP 124 and the UE 116, which may be referred to as Delay (UE, T-NP), may be determined based on a difference between a time in which the target NP 124 transmits SSB 2 (for example, T1) and a time in which the UE 116 receives SSB 2 (for example, T2). The UE 116 may calculate the delay based on a location of the UE 116 and an NTN configuration of the target NP 124.

The network may provide SMTC 908 based on a UE-NP propagation delay of zero. The UE 116 may adjust the timing of the SMTC 908 with the calculated delay to generate an adjusted SMTC 912. The UE 116 may use the adjusted SMTC 912 for serving cell measurements based on SSB 2.

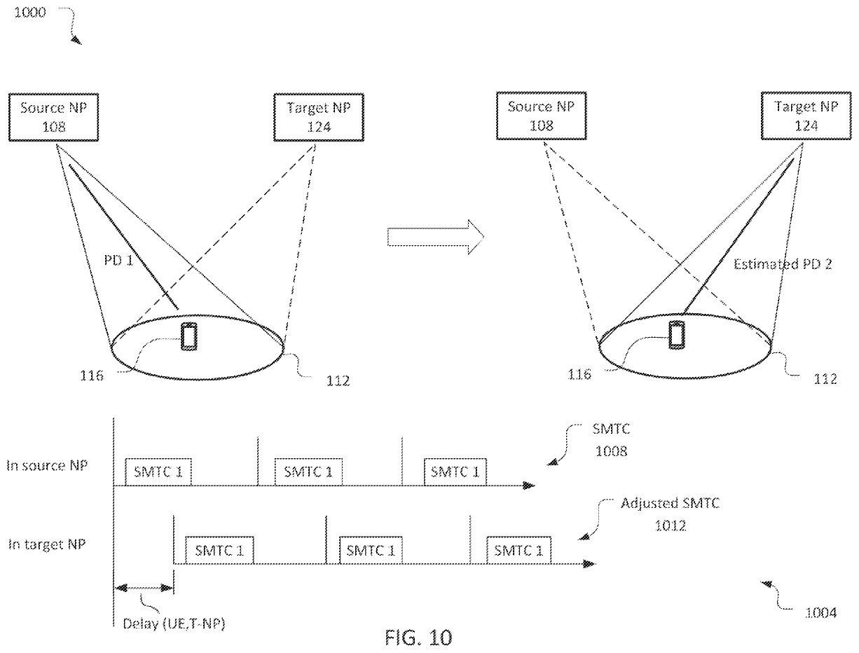

FIG. 10 illustrates a switch procedure 1000 and an accompanying timing diagram 1004 illustrating the second option of the second aspect for performing the SMTC adjustment at the UE 116 in accordance with some embodiments.

The UE 116 may have a propagation delay (PD 1) associated with the source NP 108. Before/upon NP switching, the UE 116 may estimate a propagation delay (PD 2) associated with the target NP 124. The propagation delay (PD 2) may be estimated based on an NIN configuration of the target NP 124 and a location of the UE 116. The UE 116 may then derive the source-target PDD as PDD=PD 2−PD 1.

The network may provide SMTC 1008 based on an estimated source-target PDD of zero. The UE 116 may adjust the timing of the SMTC 1008 with the PDD it estimated (for example, PD 2−PD 1) to generate an adjusted SMTC 1012. The UE 116 may use the adjusted SMTC 1012 for serving cell measurements based on SSB 2.

Some embodiments describe SMTC adjustment with respect to a neighbor cell measurement after an NP switch. This may be done in accordance with one of the following two options. In a first option, the UE 116 may not adjust the SMTC for the neighbor cell measurement. The UE 116 may keep the SMTC for neighbor-cell measurement until the network provides a new SMTC based on timing of the target NP 124. In a second option, the UE 116 may adjust the SMTC for a neighbor-cell measurement based on a source-target PDD. This may be the case if the target NP 124 provides multiple cells including, for example, the serving cell 112 and a neighbor cell. With respect to the second option, the network may not need to provide the SMTC reconfiguration via dedicated signaling.

Some embodiments describe enhancements with respect to the UE 116 reporting PDD to the network via the target NP 124.

Two types of PDD reporting may be considered. In a first type, described as source-target PDD elsewhere herein, the PDD represents a difference between a propagation delay associated with the source NP 108 and a propagation delay associated with the target NP 124. In the second type, which may be described as a target-neighbor PDD, the PDD represents a difference between a propagation delay associated with the target NP 124 and a propagation delay associated with an NP providing a neighbor cell.

The PDD reporting may be triggered in accordance with one or more of the following options. In a first option, a PDD report may be triggered based on the NP switching. In a second option, a PDD report may be triggered when a value of the PDD exceeds a predetermined threshold. The predetermined threshold may be defined for the NP switching case. In some embodiments, the predetermined threshold may be defined by a 3GPP TS (for example, 3GPP TS 38.331). In other embodiments, the predetermined threshold may be dynamically configured by the network.

In some embodiments, the PDD report may be a one-shot report. For example, upon detecting an associated trigger event, the UE 116 may send one PDD report. In other embodiments, the PDD report may be a periodic report. For example, upon detecting and associated trigger event, the UE 116 may begin to send PDD reports with a predetermined periodicity. The UE 116 may cease sending the PDD reports once the trigger event is no longer detected.

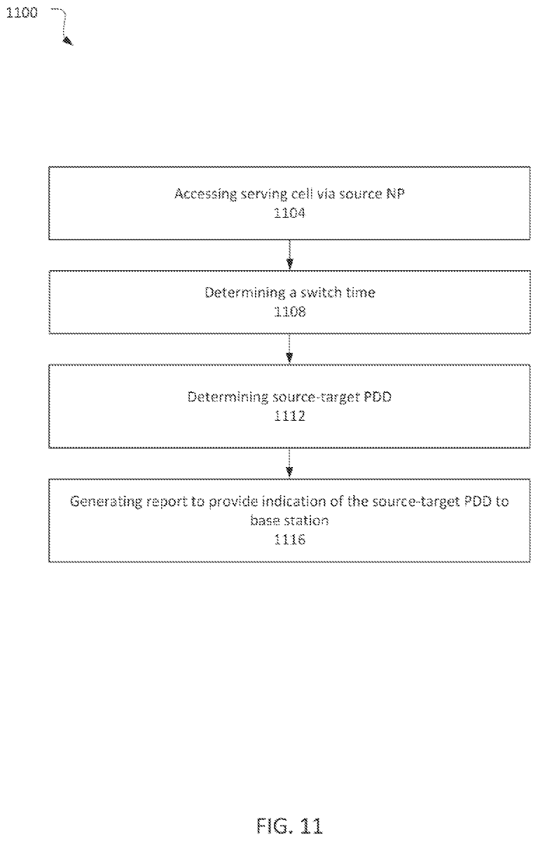

FIG. 11 illustrates an operational flow/algorithmic structure 1100 in accordance with some embodiments. The operation flow/algorithmic structure 1100 may be performed or implemented by a UE such as, for example, UE 116 or 1400; or components thereof, for example, baseband processor circuitry 1404A.

The operation flow/algorithmic structure 1100 may include, at 1104, accessing a service cell via a source NP.

The operation flow/algorithmic structure 1100 may further include, at 1108, determining a switch time. After the switch time, the serving cell is to be provided by a target NP. To access the serving cell through the target NP, the UE may perform a DL sync detection and serving cell measurements based on SSBs transmitted by the target NP. This may be done based on an SMTC provided by the network, which may or may not be adjusted by the UE.

In some embodiments, the switch time may be determined based on an NTN configuration associated with the source NP. The NTN configuration may indicate a service time in which the source NP is to provide the serving cell. In other embodiments, the switch time may be determined based on an explicit or implicit indication provided to the UE by the network. In some embodiments, the switch time may be a hard-switch time provided by the network. In other embodiments, the switch time may be a soft-switch time that is selected by the UE within a soft-switch duration provided by the network.

The operation flow/algorithmic structure 1100 may further include, at 1112, determining a source-target PDD. The UE may determine the source-target PDD as a difference between a first propagation delay associated with the source NP and a second propagation delay associated with the target NP. The propagation delays may be determined by the UE based on NTN configuration information (for example, ephemeris information) associated with the respective NPs and a location of the UE.

The operation flow/algorithmic structure 1100 may further include, at 1116, generating a report to provide an indication of the source-target PDD to a base station. In some embodiments, the base station may use the source-target PDD to update an SMTC, which may then be provided to the UE facilitate detection/measurement of SSBs transmitted by the target NP.

In some embodiments, the UE may process a first RRC message to detect a first SMTC associated with the target NP. After the switch time and prior to transmission of the PDD report, the UE may acquire DL sync of the target NP based on the first SMTC. After sending the PDD report, the UE may process a second RRC message to detect a second SMTC associated with the target NP. The second SMTC may be adjusted by the NW based on the PDD report. The UE may then measure an SSB from the target NP based on the second SMTC.

In some embodiments, the UE may acquire the downlink synchronization with the target NP by adjusting a window to track one or SSBs from the target NP. The window adjustment may be based on the source-target PDD and SSB time offset, if provided.

In some embodiments, the UE may detect a trigger based on processing of an RRC message. The UE may then generate the report based on detecting the trigger. The UE may then process another RRC message to detect an SMTC associated with the target NP. This SMTC, which may be received before the switch time, may be generated by the network based on the reported source-target PDD. The UE may then detect an SSB of the target NP based on the SMTC. The SSB may be used to acquire downlink synchronization of the target NP and for performing a serving cell measurement.

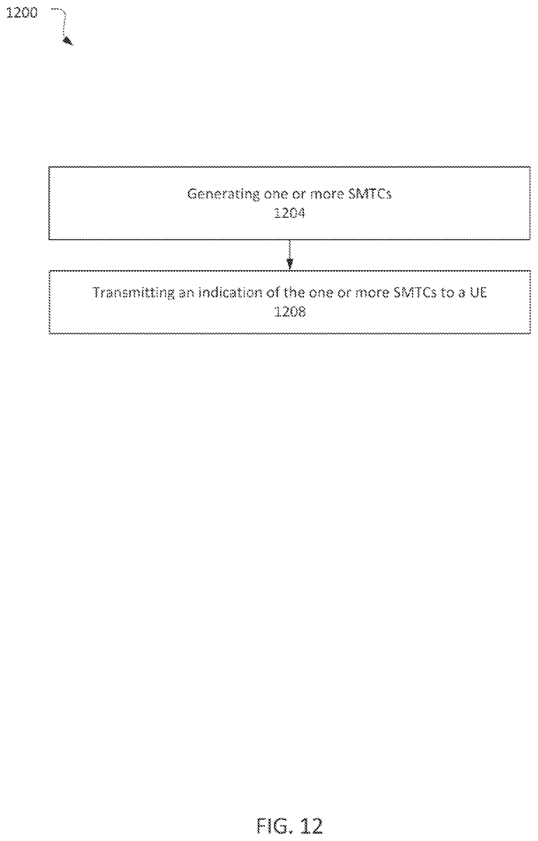

FIG. 12 illustrates an operational flow/algorithmic structure 1200 in accordance with some embodiments. The operation flow/algorithmic structure 1200 may be performed or implemented by a base station such as, for example, base station 106 or network device 1500; or components thereof, for example, baseband processor 1504A.

The operation flow/algorithmic structure 1200 may include, at 1204, generating one or more SMTCs. Each SMTC may be associated with a respective window. The one or more windows may encompass a SSBs transmitted by a source NP and a target NP. In some embodiments, the one or SMTCs may include one SMTC associated with one measurement window that encompasses SSBs from both the source NP and the target NP. In other embodiments, the one or SMTCs may include first and second SMTCs. The first SMTC may provide a first window that encompasses an SSB from the source NP while the second SMTC provides a second window that encompasses an SSB from the target NP.

The operation flow/algorithmic structure 1200 may further include, at 1208, transmitting an indication of the one or more SMTCs to a UE.

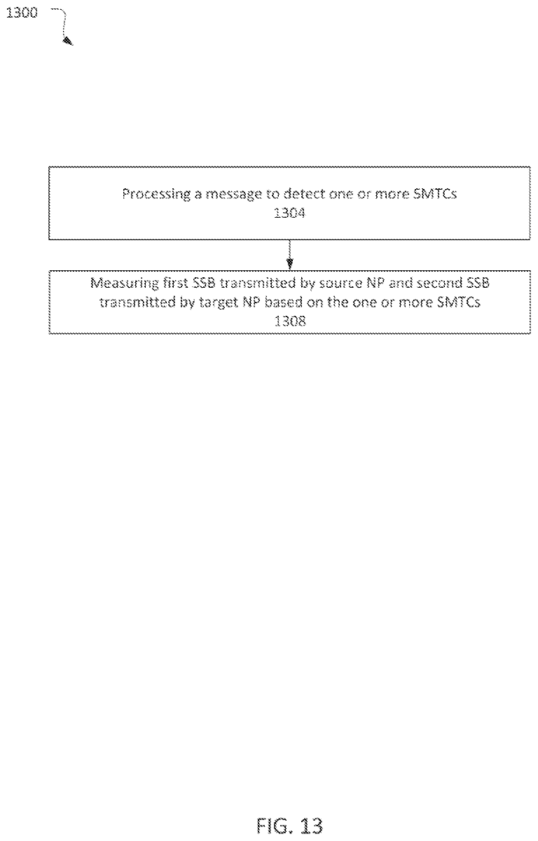

FIG. 13 illustrates an operational flow/algorithmic structure 1300 in accordance with some embodiments. The operation flow/algorithmic structure 1300 may be performed or implemented by a UE such as, for example, UE 116 or 1400; or components thereof, for example, baseband processor circuitry 1404A.

The operation flow/algorithmic structure 1300 may include, at 1304, processing a message to detect one or more SMTCs. The one or more SMTCs may configure windows similar to those described above with respect to operation flow/algorithmic structure 1200.

The operation flow/algorithmic structure 1300 may further include, at 1308, measuring a first SSB transmitted by a source NP and a second SSB transmitted by a target NP based on the one or SMTCs.

In the event one window encompasses both SSBs transmitted from the source NP and the target NP, the UE may use the window to measure the first SSB transmitted by the source NP in a measurement period that occurs before an NP switch and may use the window to measure the second SSB transmitted by the target NP in a measurement period that occurs after the NP switch.

In some embodiments, the UE may adjust the SMTC to obtain an adjusted SMTC. The adjustment may be based on assistance information associated with the target NP and location information associated with the UE. The assistance information may be received in a SIB message transmitted by the network. The adjusted SMTC may be used to measure the second SSB transmitted by the target NP.

In the event a first window (defined by first SMTC) encompasses the first SSB and a second window (defined by second SMTC) encompasses the second SSB, the UE may use the first window to measure the first SSB in a measurement period that occurs before an NP switch and may use the second window to measure the second SSB in a measurement period that occurs after the NP switch.

In some embodiments, the UE may adjust the second SMTC to obtain an adjusted SMTC. The adjustment may be based on a source-target PDD. The adjusted SMTC may be used to measure the second SSB transmitted by the target NP.

In some embodiments, the UE may use the source-target PDD to adjust an SMTC for neighbor cell measurements. For example, the UE may be provided with an SMTC for neighbor cell measurements by a serving cell. The UE may then adjust the SMTC based on the source-target PDD. After the NP switch, the UE may use the adjusted SMTC to measure an SSB transmitted by a neighbor NP.

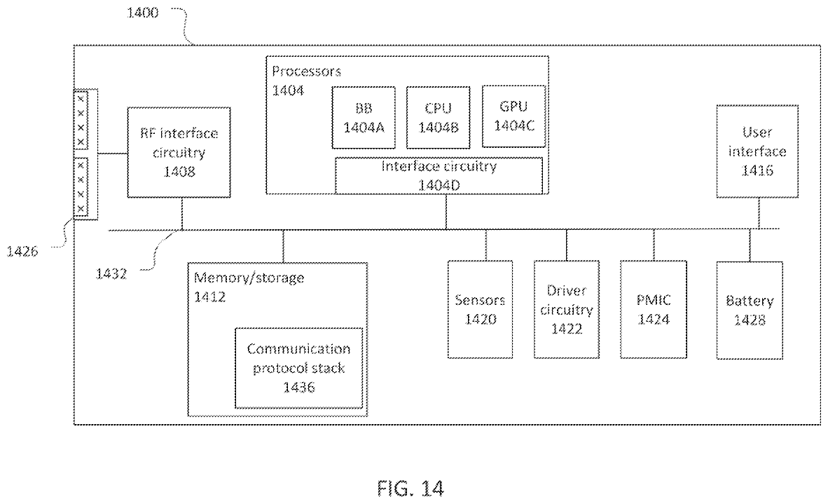

FIG. 14 illustrates a UE 1400 in accordance with some embodiments. The UE 1400 may be similar to and substantially interchangeable with UE 116.

The UE 1400 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, or actuators), video surveillance/monitoring devices (for example, cameras or video cameras), wearable devices (for example, a smart watch), or Internet-of-things devices.

The UE 1400 may include processors 1404, RF interface circuitry 1408, memory/storage 1412, user interface 1416, sensors 1420, driver circuitry 1422, power management integrated circuit (PMIC) 1424, antenna 1426, and battery 1428. The components of the UE 1400 may be implemented as integrated circuits (ICs), portions thereof, discrete electronic devices, or other modules, logic, hardware, software, firmware, or a combination thereof. The block diagram of FIG. 14 is intended to show a high-level view of some of the components of the UE 1400. However, some of the components shown may be omitted, additional components may be present, and different arrangement of the components shown may occur in other implementations.

The components of the UE 1400 may be coupled with various other components over one or more interconnects 1432, which may represent any type of interface, input/output, bus (local, system, or expansion), transmission line, trace, or optical connection that allows various circuit components (on common or different chips or chipsets) to interact with one another.

The processors 1404 may include processor circuitry such as, for example, baseband processor circuitry (BB) 1404A, central processor unit circuitry (CPU) 1404B, and graphics processor unit circuitry (GPU) 1404C. The processors 1404 may include any type of circuitry or processor circuitry that executes or otherwise operates computer-executable instructions, such as program code, software modules, or functional processes from memory/storage 1412 to cause the UE 1400 to perform NP switching operations as described herein. The processors 1404 may also include interface circuitry 1404D to communicatively couple the processor circuitry with one or more other components of the UE 1400.

In some embodiments, the baseband processor circuitry 1404A may access a communication protocol stack 1436 in the memory/storage 1412 to communicate over a 3GPP compatible network. In general, the baseband processor circuitry 1404A may access the communication protocol stack 1436 to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a NAS layer. In some embodiments, the PHY layer operations may additionally/alternatively be performed by the components of the RF interface circuitry 1408.

The baseband processor circuitry 1404A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The memory/storage 1412 may include one or more non-transitory, computer-readable media that includes instructions (for example, communication protocol stack 1436) that may be executed by one or more of the processors 1404 to cause the UE 1400 to perform various operations described herein. The memory/storage 1412 may store NP information upon which the NP switching procedures described herein are based.

The memory/storage 1412 includes any type of volatile or non-volatile memory that may be distributed throughout the UE 1400. In some embodiments, some of the memory/storage 1412 may be located on the processors 1404 themselves (for example, memory/storage 1412 may be part of a chipset that corresponds to the baseband processor 1404A), while other memory/storage 1412 is external to the processors 1404 but accessible thereto via a memory interface. The memory/storage 1412 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1408 may include transceiver circuitry and a radio frequency front module (RFEM) that allows the UE 1400 to communicate with other devices over a radio access network. The RF interface circuitry 1408 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna 1426 and proceed to filter and amplify (with a low-noise amplifier) the signal. The signal may be provided to a receiver of the transceiver that down-converts the RF signal into a baseband signal that is provided to the baseband processor of the processors 1404.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1426.

In various embodiments, the RF interface circuitry 1408 may be configured to transmit/receive signals in a manner compatible with NR access technologies.

The antenna 1426 may include antenna elements to convert electrical signals into radio waves to travel through the air and to convert received radio waves into electrical signals. The antenna elements may be arranged into one or more antenna panels. The antenna 1426 may have antenna panels that are omnidirectional, directional, or a combination thereof to enable beamforming and multiple input, multiple output communications. The antenna 1426 may include microstrip antennas, printed antennas fabricated on the surface of one or more printed circuit boards, patch antennas, or phased array antennas. The antenna 1426 may have one or more panels designed for specific frequency bands including bands in FR1 or FR2.

The user interface 1416 includes various input/output (I/O) devices designed to enable user interaction with the UE 1400. The user interface 1416 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 1400.

The sensors 1420 may include devices, modules, or subsystems whose purpose is to detect events or changes in their environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 1422 may include software and hardware elements that operate to control particular devices that are embedded in the UE 1400, attached to the UE 1400, or otherwise communicatively coupled with the UE 1400. The driver circuitry 1422 may include individual drivers allowing other components to interact with or control various input/output (I/O)) devices that may be present within, or connected to, the UE 1400. For example, driver circuitry 1422 may include a display driver to control and allow access to a display device, a touchscreen driver to control and allow access to a touchscreen interface, sensor drivers to obtain sensor readings of sensors 1420 and control and allow access to sensors 1420, drivers to obtain actuator positions of electro-mechanic components or control and allow access to the electro-mechanic components, a camera driver to control and allow access to an embedded image capture device, audio drivers to control and allow access to one or more audio devices.

The PMIC 1424 may manage power provided to various components of the UB 1400. In particular, with respect to the processors 1404, the PMIC 1424 may control power-source selection, voltage scaling, battery charging, or DC-to-DC conversion.

In some embodiments, the PMIC 1424 may control, or otherwise be part of, various power-saving mechanisms of the UE 1400 including DRX as discussed herein.

A battery 1428 may power the UE 1400, although in some examples the UE 1400 may be mounted deployed in a fixed location and may have a power supply coupled to an electrical grid. The battery 1428 may be a lithium ion battery, a metal-air battery, such as a zinc-air battery, an aluminum-air battery, a lithium-air battery, and the like. In some implementations, such as in vehicle-based applications, the battery 1428 may be a typical lead-acid automotive battery.

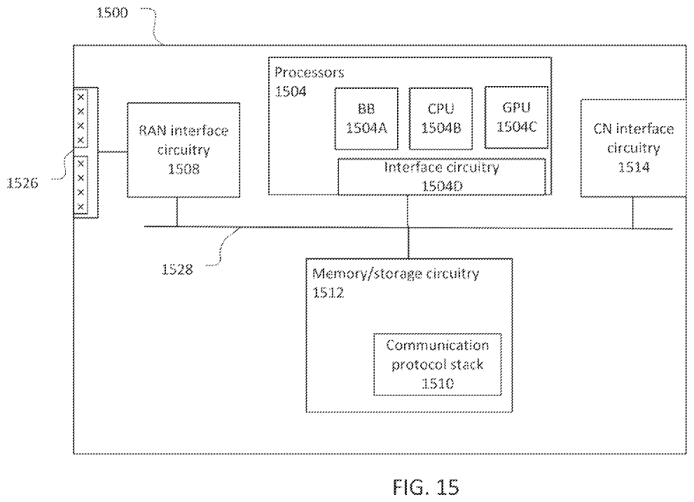

FIG. 15 illustrates a network device 1500 in accordance with some embodiments. The network device 1500 may be similar to and substantially interchangeable with base station 106, source NP 108, or target NP 124.

The network device 1500 may include processors 1504, RF interface circuitry 1508 (if implemented as a base station), core network (CN) interface circuitry 1514, memory/storage circuitry 1512, and antenna structure 1526.

The components of the network device 1500 may be coupled with various other components over one or more interconnects 1528.

The processors 1504, RF interface circuitry 1508, memory/storage circuitry 1512 (including communication protocol stack 1510), antenna structure 1526, and interconnects 1528 may be similar to like-named elements shown and described with respect to FIG. 14.

The processors 1504 may include processor circuitry such as, for example, baseband processor circuitry (BB) 1504A, central processor unit circuitry (CPU) 1504B, and graphics processor unit circuitry (GPU) 1504C. The processors 1504 may include any type of circuitry or processor circuitry that executes or otherwise operates computer-executable instructions, such as program code, software modules, or functional processes from memory/storage circuitry 1512 to cause the UE 1400 to perform NP switching operations as described herein. The processors 1504 may also include interface circuitry 1504D to communicatively couple the processor circuitry with one or more other components of the network device 1500.

The CN interface circuitry 1514 may provide connectivity to a core network, for example, a 5^{th} Generation Core network (5GC) using a 5GC-compatible network interface protocol such as carrier Ethernet protocols, or some other suitable protocol. Network connectivity may be provided to/from the network device 1500 via a fiber optic or wireless backhaul. The CN interface circuitry 1514 may include one or more dedicated processors or FPGAs to communicate using one or more of the aforementioned protocols. In some implementations, the CN interface circuitry 1514 may include multiple controllers to provide connectivity to other networks using the same or different protocols.

In some embodiments, the network device 1500 may be a base station and may be coupled with satellites using the antenna structure 1526. In other embodiments, the network device 1500 may be a satellite and may be coupled with the base station using the antenna structure 1526.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, or network element as described above in connection with one or more of the preceding figures may be configured to operate in accordance with one or more of the examples set forth below in the example section.

### EXAMPLES

In the following sections, further exemplary embodiments are provided.

Example 1 includes a method comprising: accessing a serving cell provided by a source non-terrestrial network payload (NP); determining a switch time after which the serving cell is to be provided by a target NP; determining a difference between a first propagation delay associated with the source NP and a second propagation delay associated with the target NP; and generating a report to provide an indication of the difference to a base station.

Example 2 includes a method of example 1 or some other example herein, further comprising: processing a first radio resource control (RRC) message to detect a synchronization signal/physical broadcast channel block measurement timing configuration (SMTC) associated with the target NP; acquiring, after the switch time and prior to transmitting the indication of the difference to the base station, downlink synchronization with the target NP based on the first SMTC; and processing a second RRC message to detect a second SMTC associated with the target NP, wherein the second RRC message is received after the report is transmitted to the base station.

Example 3 includes the method of example 2 or some other example herein, further comprising: receiving a synchronization signal/physical broadcast channel block (SSB) time offset; and wherein acquiring the downlink synchronization with the target NP includes adjusting, based on the difference and the SSB time offset, a window to track one or more SSBs from the target NP.

Example 4 includes a method of example 1 or some other example herein, further comprising: processing a radio resource control (RRC) message to detect a trigger; and generating the report based on detection of the trigger.

Example 5 includes a method of example 4 some other example herein, wherein the RRC message is a first RRC message and the method further comprises: processing a second RRC message to detect a synchronization signal/physical broadcast channel block measurement timing configuration (SMTC) associated with the target NP, wherein the second RRC message is received before the switch time.

Example 6 includes a method of example 5 or some other example herein, further comprising: detecting a synchronization signal/physical broadcast channel block (SSB) of the target NP based on the SMTC; acquiring downlink synchronization of the target NP based on the SSB; and performing a serving cell measurement based on the SSB.

Example 7 includes a method to be implemented by a base station, the method comprising: generating one or more synchronization signal/physical broadcast channel block measurement timing configurations (SMTCs) associated with a respective one or more measurement windows, wherein the one or more measurement windows are to encompass a first synchronization signal/physical broadcast channel block (SSB) transmitted by a source non-terrestrial network payload (NP) and a second SSB transmitted by a target NP; and transmitting an indication of the one or more SMTCs in a service cell provided by the source NP.

Example 8 includes the method of example 7 or some other example herein, wherein the one or more SMTCs comprise one SMTC associated with one measurement window that encompasses the first and second SSBs.

Example 9 includes the method of example 7 or some other example herein, wherein the one or more SMTCs comprise a first SMTC associated with a first measurement window that encompasses the first SSB; and a second SMTC associated with a second measurement window that encompasses the second SSB.

Example 10 includes a method comprising processing a message to detect one or more synchronization signal/physical broadcast channel block measurement timing configurations (SMTCs); and measuring a first synchronization signal/physical broadcast channel block (SSB) transmitted by a source non-terrestrial network payload (NP) and a second SSB transmitted by a target NP based on the one or more SMTCs, wherein the source NP is to provide a serving cell before a switch time and the target NP is to provide the serving cell after the switch time.

Example 11 includes the method of example 10 or some other example herein, wherein the one or more SMTCs comprise an SMTC and the method further comprises: measuring, before the switch time, the first SSB based on the SMTC; and measuring, after the switch time, the second SSB based on the SMTC.

Example 12 includes the method of example 11 or some other example herein, further comprising: determining, based on a system information block (SIB) message, assistance information associated with the target NP; determining, based on location information associated with a user equipment (UE) and the assistance information, a delay; adjusting, based on the delay, the SMTC to obtain an adjusted SMTC; and measuring the second SSB based on the adjusted SMTC.

Example 13 includes the method of example 10 or some other example herein, wherein the one or more SMTCs comprise a first SMTC and a second SMTC and the method further comprises: measuring, before the switch time, the first SSB based on the first SMTC; and measuring, after the switch time, the second SSB based on the second SMTC.

Example 14 includes the method of example 13 or some other example herein, further comprising: determining a difference between a first propagation delay associated with the source NP and a second propagation delay associated with the target NP; adjusting, based on the difference, the second SMTC to obtain an adjusted SMTC; and measuring the second SSB based on the adjusted SMTC.

Example 15 includes the method of example 10 or some other example herein, further comprising: measuring, after the switch time, a third SSB of a neighbor cell based on an unadjusted SMTC of the one or more SMTCs.

Example 16 includes the method of example 10 or some other example herein, further comprising: determining a difference between a first propagation delay associated with a source NP and a second propagation delay associated with the target NP; adjusting, based on the difference, an SMTC of the one or more SMTCs to obtain an adjusted SMTC; and measuring, after the switch time, a third SSB transmitted by a neighbor NP based on the adjusted SMTC.

Example 17 includes the method of example 10 or some other example herein, further comprising: determining a difference between a first propagation delay and a second propagation delay; detecting a trigger event; and causing, based on said detecting the trigger event, a message to be transmitted to a base station, wherein the message includes an indication of the difference.

Example 18 includes the method of example 17 or some other example herein, wherein: the first propagation delay is associated with the source NP and the second propagation delay is associated with the target NP; or the first propagation delay is associated with the target NP and the second propagation delay is associated with a neighbor NP.

Example 19 includes the method of example 17 or some other example herein, wherein: the trigger event is associated with the switch time; or the trigger event is based on the difference being greater than a predetermined threshold.

Example 20 includes the method of example 17 or some other example herein, wherein the message is a one-shot report or is a periodic report.

Another example may include an apparatus comprising means to perform one or more elements of a method described in or related to any of examples 1-20, or any other method or process described herein.

Another example may include one or more non-transitory computer-readable media comprising instructions to cause an electronic device, upon execution of the instructions by one or more processors of the electronic device, to perform one or more elements of a method described in or related to any of examples 1-20, or any other method or process described herein.

Another example may include an apparatus comprising logic, modules, or circuitry to perform one or more elements of a method described in or related to any of examples 1-20, or any other method or process described herein.

Another example may include a method, technique, or process as described in or related to any of examples 1-20, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-20, or portions thereof.

Another example may include a signal as described in or related to any of examples 1-20, or portions or parts thereof.

Another example may include a datagram, information element, packet, frame, segment, PDU, or message as described in or related to any of examples 1-20, or portions or parts thereof, or otherwise described in the present disclosure.

Another example may include a signal encoded with data as described in or related to any of examples 1-20, or portions or parts thereof, or otherwise described in the present disclosure.

Another example may include a signal encoded with a datagram, IE, packet, frame, segment, PDU, or message as described in or related to any of examples 1-20, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-20, or portions thereof.

Another example may include a computer program comprising instructions, wherein execution of the program by a processing element is to cause the processing element to carry out the method, techniques, or process as described in or related to any of examples 1-20, or portions thereof.

Another example may include a signal in a wireless network as shown and described herein.

Another example may include a method of communicating in a wireless network as shown and described herein.

Another example may include a system for providing wireless communication as shown and described herein.

Another example may include a device for providing wireless communication as shown and described herein.

Any of the above-described examples may be combined with any other example (or combination of examples), unless explicitly stated otherwise. The foregoing description of one or more implementations provides illustration and description but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

1.-20. (canceled)

21. An apparatus comprising:
processing circuitry to:
access a serving cell provided by a source non-terrestrial network payload (NP);
determine a switch time after which the serving cell is to be provided by a target NP;
determine a difference between a first propagation delay associated with the source NP and a second propagation delay associated with the target NP; and
generate, for transmission to a network, a report that includes an indication of the difference; and
interface circuitry coupled to the processing circuitry to enable communication.

22. The apparatus of claim 21, wherein the processing circuitry is further to:
process a first radio resource control (RRC) message to detect a synchronization signal/physical broadcast channel block measurement timing configuration (SMTC) associated with the target NP;
acquire, after the switch time and prior to transmission of the report to the base station, downlink synchronization with the target NP based on the first SMTC; and
process a second RRC message to detect a second SMTC associated with the target NP, wherein the second RRC message is received after the report is transmitted to the base station.

23. The apparatus of claim 22, wherein the processing circuitry is further to:
receive a synchronization signal/physical broadcast channel block (SSB) time offset; and
adjust, based on the difference and the SSB time offset, a window to track one or more SSBs from the target NP to acquire the downlink synchronization with the target NP.

24. The apparatus of claim 21, wherein the processing circuitry is further to:
process a radio resource control (RRC) message to detect a trigger; and
generate the report based on detection of the trigger.

25. The apparatus of claim 24, wherein the RRC message is a first RRC message and the processing circuitry is further to:
process a second RRC message to detect a synchronization signal/physical broadcast channel block measurement timing configuration (SMTC) associated with the target NP, wherein the second RRC message is received before the switch time.

26. The apparatus of claim 25, wherein the processing circuitry is further to:
detect a synchronization signal/physical broadcast channel block (SSB) of the target NP based on the SMTC;
acquire downlink synchronization of the target NP based on the SSB; and
perform a serving cell measurement based on the SSB.

27. A method comprising:
generating one or more synchronization signal/physical broadcast channel block measurement timing configurations (SMTCs) associated with a respective one or more measurement windows, wherein the one or more measurement windows are to encompass a first synchronization signal/physical broadcast channel block (SSB) transmitted by a source non-terrestrial network payload (NP) and a second SSB transmitted by a target NP; and
outputting, for transmission in a serving cell provided by the source NP, an indication of the one or more SMTCs.

28. The method of claim 27, wherein the one or more SMTCs comprise one SMTC associated with one measurement window that encompasses the first and second SSBs.

29. The method of claim 27, wherein the one or more SMTCs comprise a first SMTC associated with a first measurement window that encompasses the first SSB; and a second SMTC associated with a second measurement window that encompasses the second SSB.

30. One or more non-transitory, computer-readable media having instructions that, when executed, cause processing circuitry to:
process a message to detect one or more synchronization signal/physical broadcast channel block measurement timing configurations (SMTCs); and
measure a first synchronization signal/physical broadcast channel block (SSB) transmitted by a source non-terrestrial network payload (NP) and a second SSB transmitted by a target NP based on the one or more SMTCs, wherein the source NP is to provide a serving cell before a switch time and the target NP is to provide the serving cell after the switch time.

31. The one or more non-transitory, computer-readable media of claim 30, wherein the one or more SMTCs comprise an SMTC and the instructions, when executed, further cause the processing circuitry to:
measure, before the switch time, the first SSB based on the SMTC; and
measure, after the switch time, the second SSB based on the SMTC.

32. The one or more non-transitory, computer-readable media of claim 31, wherein the instructions, when executed, further cause the processing circuitry to:
determine, based on a system information block (SIB) message, assistance information associated with the target NP;
determine, based on location information associated with a user equipment (UE) and the assistance information, a delay;
adjust, based on the delay, the SMTC to obtain an adjusted SMTC; and
measure the second SSB based on the adjusted SMTC.

33. The one or more non-transitory, computer-readable media of claim 30, wherein the one or more SMTCs comprise a first SMTC and a second SMTC and the instructions, when executed, further cause the processing circuitry to:
measure, before the switch time, the first SSB based on the first SMTC; and
measure, after the switch time, the second SSB based on the second SMTC.

34. The one or more non-transitory, computer-readable media of claim 33, wherein the instructions, when executed, further cause the processing circuitry to:
determine a difference between a first propagation delay associated with the source NP and a second propagation delay associated with the target NP;
adjust, based on the difference, the second SMTC to obtain an adjusted SMTC; and
measure the second SSB based on the adjusted SMTC.

35. The one or more non-transitory, computer-readable media of claim 30, wherein the instructions, when executed, further cause the processing circuitry to:
measure, after the switch time, a third SSB of a neighbor cell based on an unadjusted SMTC of the one or more SMTCs.

36. The one or more non-transitory, computer-readable media of claim 30, wherein the instructions, when executed, further cause the processing circuitry to:
determine a difference between a first propagation delay associated with a source NP and a second propagation delay associated with the target NP;
adjust, based on the difference, an SMTC of the one or more SMTCs to obtain an adjusted SMTC; and
measure, after the switch time, a third SSB transmitted by a neighbor NP based on the adjusted SMTC.

37. The one or more non-transitory, computer-readable media of claim 30, wherein the instructions, when executed, further cause the processing circuitry to:
determine a difference between a first propagation delay and a second propagation delay;
detect a trigger event; and
generate, based on detection of the trigger event, a report to be transmitted to a base station, wherein the report includes an indication of the difference.

38. The one or more non-transitory, computer-readable media of claim 37, wherein:
the first propagation delay is associated with the source NP and the second propagation delay is associated with the target NP; or
the first propagation delay is associated with the target NP and the second propagation delay is associated with a neighbor NP.

39. The one or more non-transitory, computer-readable media of claim 37, wherein:
the trigger event is associated with the switch time; or
the trigger event is based on the difference being greater than a predetermined threshold.

40. The one or more non-transitory, computer-readable media of claim 37, wherein the message is a one-shot report or is a periodic report.
